(19) United States
(12) Patent Application Publication
(10) Pub. No.: US 2002/0029290 A1
(43) Pub. Date: Mar. 7, 2002

(54) System and method for tracking affiliates and merchants

(76) Inventors: Herman Burema, Tokyo (JP); Yoshia Makino, Tokyo (JP)

Correspondence Address: Kevin R. Spivak, Morrison & Foerster LLP, Suite 5500, 2000 Pennsylvania Avenue, N.W., Washington, DC, 20006-1888, US

(21) Appl. No.: 09/922,953

(22) Filed: Aug. 7, 2001

Related U.S. Application Data
(60) Provisional application No. 60/223,735, filed on Aug. 8, 2000.

(51) Int. Cl. G06F 17/60; G06F 15/173

(52) U.S. Cl. 709/238; 705/26; 705/14

(57) ABSTRACT

A system and method for accurately tracking user activity and transactions on public and private networks. The invention tracks user identification information and transaction identification information to determine whether an affiliate has referred a user to a particular web site. When a user selects a merchant's banner from an affiliate web site, before redirecting the user's computer to the merchant's web site, information about the merchant's site is stored at the user's browser. This information is then sent from the user's browser to other network data stores and can be used to determine whether an affiliate has referred a user to a particular site.

### CLAIM OF PRIORITY

This application claims the benefit of U.S. Provisional Application No. 60/223,735, filed Aug. 8, 2000, which is hereby incorporated by reference in its entirety.

### FIELD OF THE INVENTION

The invention relates generally to data processing systems, and more specifically, to systems for tracking electronic transactions over a computer network.

### BACKGROUND OF THE INVENTION

Due to significant developments in credit card processing and logistical services, and the reach of advertising, the Internet has become a medium used for conducting electronic transactions involving the purchase of goods and services. Most electronic commerce web sites and content providers sustain their sites through the generation of electronic commerce, and advertising or subscription revenue. Internet advertising is often done through a referral affiliate scheme in which affiliate web sites are rewarded for directing customers to a merchant. Affiliate web sites use a number of different pricing schemes to charge merchants, including, for example, cost per thousand impressions (CPM) and cost per click (CPC). In a CPM pricing scheme, a merchant pays a web site owner a specified amount for each thousand web site users. For example, a CPM of $40 means that the merchant pays $40 for one thousand people to see the ad banner on the top of a Web page. This advertising scheme can become quite costly, and thus may not be affordable by small merchants targeting high-traffic web sites. In a CPC pricing scheme, the merchant pays a specified amount each time a user clicks on, or selects, a banner, or similar advertising link.

When using the CPM and CPC pricing schemes, it is hard for merchants to verify the amount of business actually directed to the merchant from an affiliate web site. However, CPM and CPC networks continue to be used extensively by large corporations that can afford relatively high advertising costs.

Affiliate web sites may alternatively use a performance marketing style of advertising. In performance marketing advertising, merchants pay an affiliate web site based solely on the number of customers the affiliate directed to the merchant. Thus, this scheme reflects the value of measuring the success ratio of a specific advertising campaign and requires merchants to only pay for advertising that generates quantitative results. The key to the success of this performance-based marketing lies in the organizations that track the activity of users and match transactions with advertising.

One of the most commonly used mechanisms for tracking web activity relies on “cookies.” A “cookie” is a small, generally less than 4 K, file which stores both identification and transaction information about a user. The cookie is stored on the user's computer and is read by the web server which created the cookie each time the user enters a web site affiliated with the server. Thus, by reading a user's cookie, a merchant can determine whether a user visited a particular web site before making a purchase, the time of such visit, and other information useful for tracking the user's web activity. Thus, cookies may be used in promotion-based advertising to determine whether an affiliate web site directed a user to a merchant's web site.

Cookie-based tracking technologies, however, fail to accurately track all users referred to a merchant. Computer users may disable cookie technology on their PC, making it impossible for a web server to create a cookie and store it on their machine to track the user's web activity. Thus, where a user has disabled cookies, any referral via an affiliate will not be tracked by the affiliate web site and the affiliate in turn would be left subsidizing the merchant's advertising campaign for free, the reverse of the contracted intention. With unprecedented growth in the Internet, the sheer number of transactions, and potentially large affiliate payments this results in affiliates and ‘virtual sales channels’ being increasingly defrauded of rightful referral commission payments.

### SUMMARY OF THE INVENTION

In one embodiment of the invention, there is a method of tracking transactions over a network. The method includes, for example, comparing client information and transaction information to determine whether a valid transaction occurred, the transaction information gathered using a script executed by the client browser and monitoring the comparison to record when a valid transaction occurs.

In one aspect of the invention, the method redirects a client to a merchant site based on a banner ad selected on an affiliate site, stores, prior to redirecting the client, the client information in a data storage device and captures the transaction information about a transaction made by the client on the merchant site.

In another aspect of the invention, the method determines whether data is available from a cookie stored on the client, wherein the determination is made by writing out the cookie to the client.

In another embodiment of the invention, there is a method to track transactions over a network. The method redirects a client to a merchant site based on a selection made at an affiliate site by the client, stores information about the redirection in a database, captures, using a script executed by the client browser, transaction information regarding the transaction, receives the transaction information indicating that the client completed a transaction at the merchant site and compares the information stored in the browser of the client with the transaction information to determine whether the affiliate referred the client to the merchant site.

In one aspect of the invention, the method also notifies the affiliate and merchant that a valid transaction has occurred.

In still another embodiment of the invention, there is a system to track transactions over a network. The system includes, for example, a browser-based transaction tracking program that records information about a transaction that occurs on a merchant site, and a tracking server to compare the information about the transaction to data stored during redirection of a client to the merchant site.

In one aspect of the invention, the system also includes an affiliate server that includes at least one link to a merchant site and a redirection program that redirects the client to the merchant site and a merchant server including a cookie creation and verification code which writes a cookie to the client, wherein when it is determined that the cookie is disabled, the transaction information is sent to the tracking server.

In yet another embodiment of the invention, there is a system to track transactions over a network. The system includes, for example, a browser-based transaction tracking program that tracks user transactions that result from an affiliate directing a user to a merchant, a client that includes a browser that stores information about a merchant site when the client is redirected to the merchant site, wherein the information is stored before the user is redirected to the merchant and an affiliate server that includes at least one link to the merchant site and a redirection program that redirects the client to the merchant.

In still another embodiment of the invention, there is a method for a third party to track transactions over a network between a client and a merchant, where the client was referred to the merchant by an affiliate. The method includes, for example, receiving from the affiliate site a link that relates to a merchant site and was selected by the client, redirecting the client to the merchant site according to the link, storing client information, using a program executed by a browser on the client, about the merchant site and the client, which is used to redirect the client to the merchant site, receiving an indication that a transaction has been completed by the client at the merchant site, and recording transaction as transaction information and determining whether the affiliate referred the client to the merchant site by comparing transaction information with the client information.

In one aspect of the invention, the transaction information is recorded using a script executed by the browser on the client.

In another aspect of the invention, the storing is transparent to the user.

In still another aspect of the invention, storing is performed before the merchant site receives the information.

In yet another aspect of the invention, determining is performed without the use of cookies.

### BRIEF DESCRIPTION OF THE DRAWINGS

FIG. 1 is an illustrative computer network suitable for practicing the invention.

FIG. 2 depicts a high level network architecture of the invention.

FIGS. 3A and 3B depict a flow diagram illustrating an embodiment of the invention.

### DETAILED DESCRIPTION OF THE INVENTION

This invention provides a system and method for accurately tracking user activity and transactions on the Internet or other public or private networks (the “tracking system”). The invention specifically focuses on accurate tracking of user activity as it relates to the generation of revenue via advertising and electronic commerce. The tracking system tracks and verifies transactions resulting from an affiliate web site directing a user to a merchant's web site. In the following description of the tracking system, the terms “partner web site,” “affiliate,” and “content provider” can be used interchangeably.

When a user selects a merchant's banner from an affiliate web site, before redirecting the user to the merchant's web site, the system calls the tracking system server, which stores information about the merchant's site and then redirects the user to the merchant's site. The redirection to the tracking system site is transparent to the user. This information captured during the redirection is stored at the user's browser, for example, via JavaScript and is logged by the tracking system server prior to being captured by a merchant. The information may thus be sent from the user's browser directly to both the tracking system server and to the merchant, either concurrently or in tandem. The system also captures transaction information reflecting a completed transaction at the merchant's web site. The transaction information is compared with the information captured during the redirection to the merchant's web site to determine whether the affiliate web site referred the user to the merchant relative to the completed transaction.

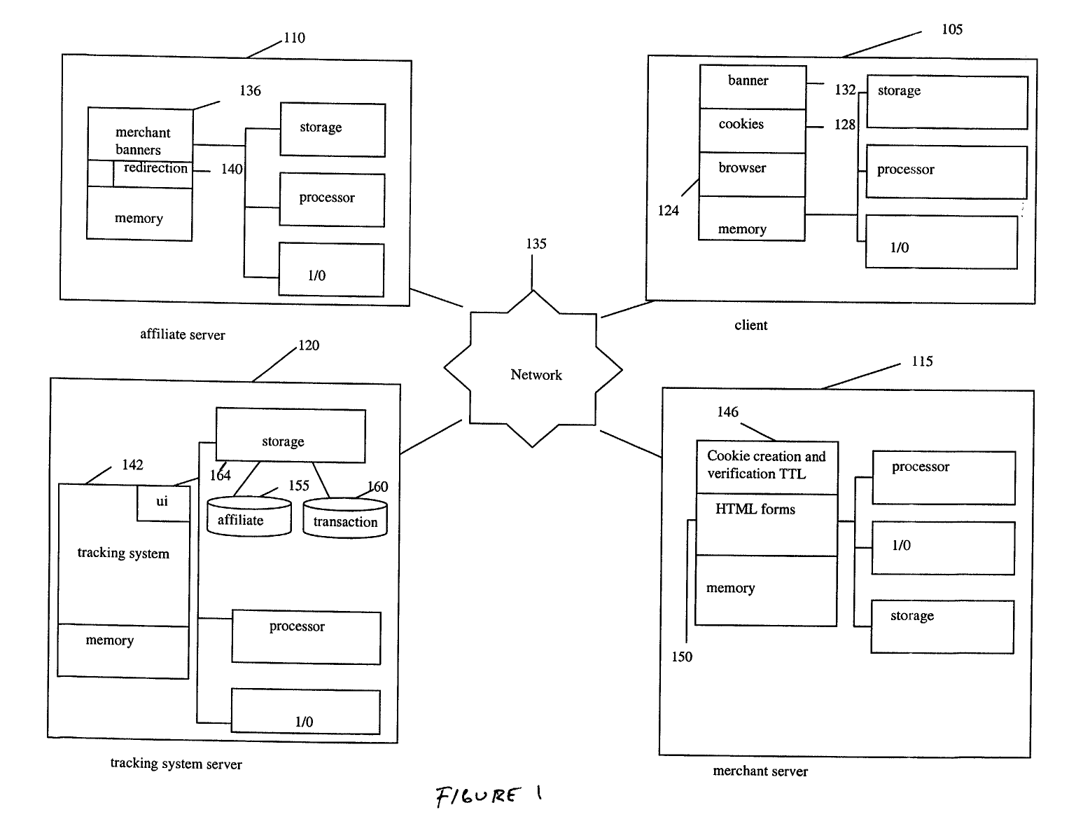

Referring to FIG. 1, computer network 100 includes client 105, affiliate server 110, merchant server 120, and tracking system server 130, each of which communicate via network 135. Network 135 may be the Internet or any other public or private network. Each of partner server 110, merchant server 120, tracking system server 130, and client 105 include the following exemplary components: memory, secondary storage, a processor, an input device, and an output device.

Client 105 communicates with partner server 110 via browser software 101, such as, Netscape Navigator™, or Microsoft Internet Explorer™. Client 105 further includes in memory cookies 128 and banner 132, which corresponds to a merchant's banner that is served from affiliate server 110.

Affiliate server 110 further includes the HTML code provided by tracking system server 120, which includes a banner retrieval link 136 and a redirection link 140. Banner retrieval link 136 allows a user to select a banner corresponding to a merchant's web site and redirection link 140 redirects a user to tracking system software 142 located in tracking system server 120. Tracking system software 142 includes a program that displays a merchant's banner 136 and redirects the client 105 to the appropriate merchant's server (web site) 115, i.e., once the merchant's banner web site or hypertext link of a web page has been selected via browser 124.

Merchant server 115 includes cookie creation and verification code 146, which is capable of writing a cookie to client 105 and communicates with tracking system software 142, and HTML forms 150. If the writing out of cookies to the client has been disabled, information that would have been included in a cookie is written to the tracking system server 120 directly from merchant server 115. Cookie creation verification code 146 further includes a transaction transmittal link 154 to tracking system software 142 that is capable of transmitting transaction information to tracking system server 120. HTML forms 150 correspond to content provided by merchant server 115, including a transaction page.

Tracking system server 120 includes tracking system software 142 that writes out a cookie 128 to client 105 and transmits transaction information to client 105, displays banner advertisements 136 associated with a merchant, and redirects client 105 to a web site, i.e., merchant server 115 associated with a selected banner. Tracking system server 150 also includes a secondary storage device including information identifying affiliate web sites, i.e., affiliate data 155 and information indicating system accesses, i.e., usage data 160. Tracking system software 142 further includes a user interface 164 that allows affiliates and merchants to customize the system.

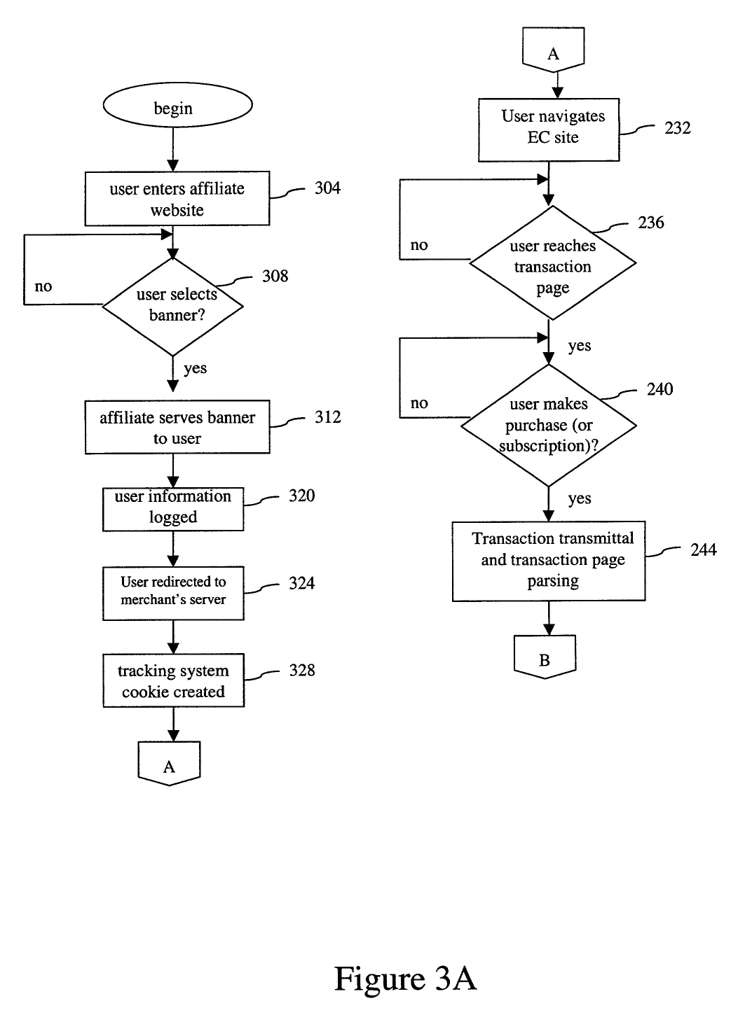

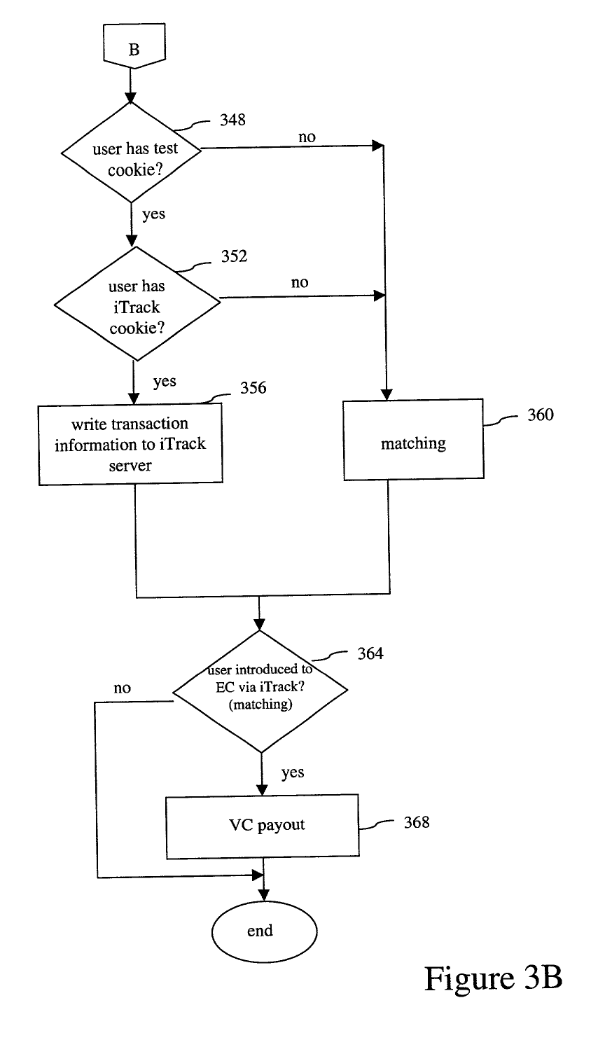

For example, when browser 132 on client 105 connects to affiliate server 110, a call is made to tracking system server 120, and the affiliate data 155 is stored and an appropriate banner 132 is returned to client 105. When a user clicks on banner 132, a call is made to the tracking system server 132 to log information identifying the user, including, for example, the user's internet protocol (IP) address and the time of the click. Then, the tracking system server 120 determines the location, i.e., the URL, of the merchant server entry page, i.e., an HTML form 150 and redirects the client 105 to that page. The user may freely browse the merchant's web site until reaching a transaction page. After making a purchase, or otherwise submitting a transaction, e.g., a subscription, the cookie creation and verification software 146 logs information about the user, writes a cookie out to the client 105, and sends the logged information to tracking system server 120 which stores the information as transaction information 160. The tracking system server 120 also writes a test cookie to the client 105 to determine whether the cookie writing function on the client 105 has been disabled. If the cookie writing function on client 105 has been disabled, a matching operation is performed to determine whether the user was referred to the merchant via the server 130. Otherwise, if the cookie function on client 105 has not been disabled, the cookies written to the user's computer are analyzed to make this determination. Further details of the operation of the invention are provided below relative to FIGS. 3A and 3B.

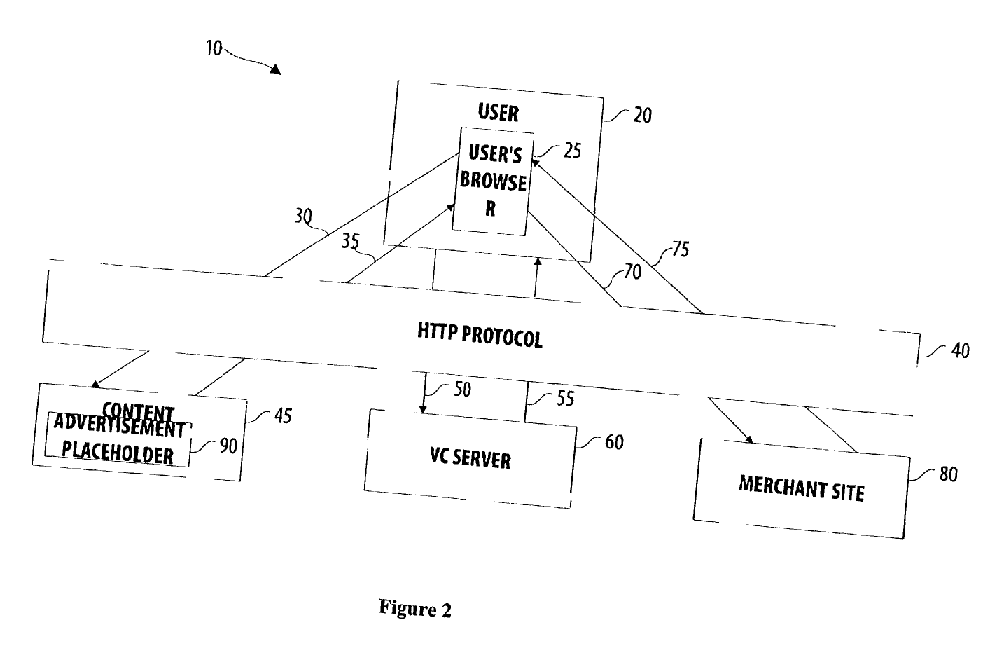

FIG. 2 depicts a high level network architecture of the invention. As depicted in the network of FIG. 2, a user interacts with content 104, a tracking system server (120), and a merchant site (115) over a network that supports a HTTP transmission protocol. The user's computer (105) includes a browser that receives and transmits both user identification information and transaction information to the network. The content 104 corresponds to content provided by a third party, such as, for example, an affiliate (110) that is associated with a merchant (115). The content 104 includes an advertisement placeholder that corresponds, for example, to a link to a page of a merchant's advertisement. Tracking system server (120) performs the coordination and storage functions, described above relative to FIG. 1.

FIGS. 3A and 3B depict a flow diagram of an embodiment of the invention. First, a merchant and an affiliate enter an arrangement whereby access to the tracking system is granted. Then, both the merchant and affiliate place the appropriate tracking system code, as described above, on their servers. Using the affiliate data 155 stored at tracking system server 120, when a user browsing the Internet accesses an affiliate web site (304), for example, via a web browser, such as Netscape Navigator™ or Microsoft Internet Explorer™ on a computer, PDA, or other network capable device, information about the merchant and affiliate is logged at tracking system server 120 and the selected banner is displayed to the user. The affiliate server may select various banners to be displayed on its web pages. Each banner includes information (1) identifying the affiliate, and (2) reflecting profile information of the banner. Thus, the affiliate server generates code having at least two identification tags: the partner site identification and the partner site banner location profile identification. Once a page including the banner is accessed, the system places a request for a banner image by placing a call to the tracking system server. More specifically, for example, the tracking system server includes a script that accesses the database and displays the image corresponding to the partner site identification and the partner site banner location profile identification, and then logs the information delivered.

This script executes code (e.g. HTML code), which may be similar to the following partner site code.

<ahref=http://ck.valuecommerce.ne.jp/cgi-bin/ck.pl?sid=s0000131&pid=p0000011 target=”_blank>

<img src=http://ad.valuecommerce.ne.jp/cgi-bin/pv.pl?sid=s000013&pid=p0000011 width=135 height=45 alt=border=0></a>

The <img> section of the code makes a call to a variable, this case “src”, which initiates execution of a banner display program. More specifically, as indicated in the above script, the <img> section of the code tracking system server calls and executes the banner display program (/cgi-bin/pv.pl) using the content provider site id (“sid”) and profile id (“pid”) as input variables. The banner display program, after checking the validity of the two input variables, makes a call to the tracking system affiliate data storage, retrieves the appropriate banner media file (GIF format image, etc.) and transmits the media file to the user's web browser. The script stores information related to the image request call, including, for example:

Content provider site id (sid)

Banner Profile id (pid)

User IP address (REMOTE_ADDR)

User browser information (HTTP_USER_AGENT)

Proxy server information (HTTP VIA)

Proxy connection address (HTTP_X_FORWARDED)

Time script was executed (timestamp)

Once the banner has been displayed on a user's screen, via a browser, the user may select the banner (308). When a user selects, i.e., clicks on, the partner site code represented as a banner or a text link, the banner is served to the user (312). Simultaneously, the user is redirected to the tracking system server, which is specified in the partner site code. In the above example, the tracking system server is identified as ck.valueconunerce.ne.jp. The tracking system server executes a redirection program that redirects the user's browser to the corresponding merchant's web site. During this redirection, the system stores information about the user (320). The content provider site identification (“sid”) and the profile identification (“pid”) are used as input variables. The script checks the validity of the input variables and generates a unique tracking system information identification, referred to herein as “TRACKING SYSTEM_INFO,” by concatenating the sid, pid and a timestamp. The script then retrieves from the affiliate data store 155 information about the affiliate and the merchant. More specifically, for example, the following information may be retrieved:

The URL of the MERCHANT site the user needs to be redirected to,

The cookie expiration date,

The domain the cookie is valid within, and

The path the cookie is valid within.

The script then redirects the user to the merchant server (324), appending this retrieved information and the tracking system information identification to the end of the merchant site URL. This appended portion is referred to as the query string. The term “redirection URL,” as used herein, refers to both the merchant site URL and the query string. In addition to the retrieved data, the script creates a unique identifier by encrypting the sid, pid, user's IP address and user browser information into a character string and writes the identifier to a file for storage. The information in the file is uploaded and stored in the transaction data store 160, which is depicted in FIG. 1 as residing in tracking system server 120, in an almost real-time fashion. Storage of this information in this manner ensures that click through information and transaction information can be matched, as described further below.

As the user enters the merchant's site that he or she has been redirected to, the tracking system software (specifically, the cookie creation and verification piece 146, which resides in merchant server 115) creates a tracking system cookie and sends the cookie and transaction information 160 to server 120 and client 105. This program can either be embedded in its entirety in the page or can be loaded to the page via the source (SRC) variable option in the <SCRIPT> HTML tag. The following is an example of the latter method.

MERCHANT site entry page code:

<SCRIPT LANGUAGE=“Javascript1.1” SRC=“http://www.valuecommerce.ne.jp/tracking system/write.js”>

</SCRIPT><script language=“Javascript1.1”>write( )</script>

This exemplary HTML text first requests and loads the cookie creation and verification program 146 which creates a cookie and promptly executes the command “write( )” which was defined in the uploaded code. The cookie creation and verification program 146 corresponds to “write.js,” which as indicated in the above code, is located in the “tracking system” directory on the tracking system server. If this code is placed between the <HEADER> tags in the HTML page, it will be loaded and executed before the body of the page, guaranteeing its execution even if the page upload is partial.

This cookie creation and verification program 146 can determine if the user was directed to the merchant server 115 by affiliate server 110 by examining parameters in the browser 124. The cookie creation and verification program 146 then reads in the query string parameters passed by the redirection URL and writes out an appropriate cookie based on this information.

As the user navigates through the merchant's web site (332), the user will eventually reach a transaction page that allows the user to make a purchase or subscription (336). This transaction page includes a “main” frame that utilizes the entire display and displays the merchant's transaction page and a “session” frame that is “invisible,” meaning it is of zero height. An invisible frame refers to a method to display two or more pages in a single browser where the main page is displayed as though it were a single page and the other page is of zero or negligible size. In order to guarantee delivery of the transaction information to the tracking system servers, the transaction information should be delivered to the tracking system server before the page performs a new task, such as, redirecting the user to another page. An invisible frame can initiate and complete delivery of the transaction information so that any changes in the “main” frame will not disrupt delivery of the transaction information. When an Internet connection is slow, for example, even though delivery may have been initiated, it may not be completed before the page begins a new task. Although guaranteed delivery can be realized either by calling the tracking system server between the transaction page and the following merchant's site page or opening another browser and then making the call to the server, for various reasons, one of which is that both methods would be too disruptive to the user, the “invisible frame” technique is described here. Therefore, one of skill in the art will appreciate that guaranteed delivery may be realized by alternative methods and remain within the scope of this invention.

During configuration of the tracking system, the merchant site is requested to rename its old transaction page and replace the HTML text with additional text, such as:

<html>

<frameset rows=“*,1” border=0>

<frame src=“<ACTUAL MERCHANT SITE TRANSACTION PAGE” name=Main scrolling=Auto frameborder=0>

<frame src=“about:blank” name=Session scrolling=No frameborder=0 noresize marginwidth=0 marginwidth=0>

</frameset>

</html>

When the user reaches the merchant transaction page (336), a transaction transmittal program is loaded from the tracking system server 120. The transaction transmittal program allows a user to make a purchase by submitting to the merchant site transaction information, such as, for example, an item to purchase an associated payment information to the merchant site (340). The transaction page guides a user through the process of submitting a transaction. When the user decides to make a purchase/subscription, the user submits the transaction information, which executes the transaction transmittal program, which operates in a manner that is similar to the merchant site entry code. For example, when a <INPUT> IHTML tag labeled “Submit,” displayed, for example, in the form of a button is selected, the user is directed by the merchant web site through a series of transaction processing pages. Implementation of this procedure may be, for example, as follows:

<FORM onSubmit=‘transmit(this,<MERCHANT site id>, <order id>, <etc>, <etc>)’>

.enter transaction information here.

<INPUT type=“submit” name=“Submit”>

</FORM>

The input parameters passed to the transaction transmittal program, depicted above as transmit( ) function, are selected by the merchant site during configuration of the tracking system by a program that runs on the tracking system server and that asks the merchant's webmaster to indicate an HTML form to be monitored by the tracking system. This transaction page is then parsed for all possible name/value pairs that can be sent to the tracking system server and these are then presented on a page to the user (344). On this page the user can then match the correct name/value pairs from the form with the required tracking system input parameters. The program will generate HTML, for example, that the webmaster can then use to add to the transaction page.

The transaction transmittal program determines whether a user has disabled the cookie feature on his or her computer as follows. If a user has a test cookie (348), then a check is made for a tracking system (352). Otherwise, if either a test cookie or a tracking system cookie does not exist, processing continues to 360. Each user having cookies enabled will have a test cookie, which was written out to the user's computer from the transaction page. If a user with cookies enabled was introduced to the merchant via an affiliate server, the user will also have a tracking system information cookie, including tracking information. For each user having an tracking system cookie, the transaction information will be sent to server 130 (356). If a user does not have any cookies, the system knows that the user has disabled the cookies feature, and the transaction information is sent to the tracking system for matching, a process which determines whether the user was referred to a merchant via a particular affiliate. The matching process is performed when a user's computer does not accept cookies.

The following operations are performed during matching (360). First, a tracking system database transaction 160, is searched to determine whether the received transaction file includes tracking system information. If the transaction file does not include tracking system information, then transaction information is matched to information recorded during the redirection to the merchant's web site. A script creates a unique identifier by encrypting, for example, the content provider site id, profile id, user's IP address, and browser information into a character string (40 characters in the preferred embodiment) which is written to a file (a text file in the preferred embodiment). The information in the file is uploaded regularly to ensure that the click-through information and the transaction information can be matched in an almost real-time manner. A merchant may further enter and store, through a portal included in the database, information recorded during the redirection to the merchant's web site. The following information may, for example, be recorded during redirection to the merchant's web site:

User IP address (REMOTE_ADDR)

User browser information (HTTP_USER_AGENT)

Proxy server information (HTTP_VIA)

Proxy connection address (HTTP_X_FORWARDED)

Redirection time

The matching operation includes the following analysis: If the received transaction file includes tracking system information, a flag is set in the database indicating that the transaction is proper. If the matching of transaction information with information recorded during redirection to the merchant site is positive, a flag is set in the database indicating that the transaction is proper. If, after performing the matching, it is determined that a user was referred to the merchant by the tracking system (364), then the affiliate is eligible for a payout amount (368). Otherwise, processing ends.

Overall, the tracking system provides a technology for accurately tracking and auditing Internet user activity, including but not limited to monitoring of electronic transactions and related activity and information on a network of interconnected public or private access computers. The technology platform provides a method for independent third parties to perform unbiased auditing, monitoring and confirmation of Internet user activity for the purpose of accurately calculating payments for services, for example, confirming electronic commerce transaction information and activity and paying a referral commission. The system also enables merchants or content providers to promote their ability to conduct legal and third-party audited electronic commerce transactions or information delivery. This in turn increases the merchant or information providers'ability to generate revenue.

One of ordinary skill in the art will appreciate that while this invention has been described relative to a particular embodiment, various changes may be made without departing from the scope of the invention. For example, while specific scripts and code have been provided as examples, alternative scripts and code may be used to perform a similar function. Accordingly, this invention is limited only by the appended claims and the full scope of their equivalents.

What is claimed is:

1. A method of tracking transactions over a network, comprising:
comparing client information and transaction information to determine whether a valid transaction occurred, the transaction information gathered using a script executed by the client browser; and
monitoring the comparison to record when a valid transaction occurs.

2. The method according to claim 1, further comprising:
redirecting a client to a merchant site based on a banner ad selected on an affiliate site;
storing prior to redirecting the client, the client information in a data storage device; and
capturing the transaction information about a transaction made by the client on the merchant site.

3. The method according to claim 2, further comprising:
determining whether data is available from a cookie stored on the client, wherein the determination is made by writing out the cookie to the client.

4. A method to track transactions over a network, comprising:
redirecting a client to a merchant site based on a selection made at an affiliate site by the client;
storing information about the redirection in a database;
capturing, using a script executed by the client browser, transaction information regarding the transaction;
receiving the transaction information indicating that the client completed a transaction at the merchant site; and
comparing the information stored in the browser of the client with the transaction information to determine whether the affiliate referred the client to the merchant site.

5. The method of claim 4, further comprising notifying the affiliate and merchant that a valid transaction has occurred.

6. A system to track transactions over a network, comprising:
a browser-based transaction tracking program that records information about a transaction that occurs on a merchant site;
a tracking server to compare the information about the transaction to data stored during redirection of a client to the merchant site.

7. The system according to claim 6, further comprising:
an affiliate server that includes at least one link to a merchant site and a redirection program that redirects the client to the merchant site; and
a merchant server including a cookie creation and verification code which writes a cookie to the client,
wherein when it is determined that the cookie is disabled, the transaction information is sent to the tracking server.

8. A system to track transactions over a network, comprising:
a browser-based transaction tracking program that tracks user transactions that result from an affiliate directing a user to a merchant;
a client that includes a browser that stores information about a merchant site when the client is redirected to the merchant site, wherein the information is stored before the user is redirected to the merchant; and
an affiliate server that includes at least one link to the merchant site and a redirection program that redirects the client to the merchant.

9. A method for a third party to track transactions over a network between a client and a merchant, where the client was referred to the merchant by an affiliate, comprising:
receiving from the affiliate site a link that relates to a merchant site and was selected by the client;
redirecting the client to the merchant site according to the link;
storing client information, using a program executed by a browser on the client, about the merchant site and the client, which is used to redirect the client to the merchant site;
receiving an indication that a transaction has been completed by the client at the merchant site, and recording transaction as transaction information; and
determining whether the affiliate referred the client to the merchant site by comparing transaction information with the client information.

10. The method according to claim 9, wherein the transaction information is recorded using a script executed by the browser on the client.

11. The method of claim 9, wherein the storing is transparent to the user.

12. The method of claim 9, wherein the storing is performed before the merchant site receives the information.

13. The method of claim 9, wherein the determining is performed without the use of cookies.
